(19) United States
(12) Patent Application Publication
(10) Pub. No.: US 2025/0018337 A1
(43) Pub. Date: Jan. 16, 2025

(54) Device for Spraying an Ammonia Gas in an Automatically-Adjusted Manner Based on a Flow Rate of a Flue Gas and a Method Thereof

(71) Applicant: Xi'an Thermal Power Research Institute Co., Ltd, Shaanxi (CN)

(72) Inventors: Dong Pan, Shaanxi (CN); Shuhong Li, Shaanxi (CN); Yudong He, Shaanxi (CN); Tong Shang, Shaanxi (CN); Zhuang Yuan, Shaanxi (CN); Shiji Yang, Shaanxi (CN); Chen Dong, Shaanxi (CN); Zhi Luo, Shaanxi (CN); Kai Shu, Shaanxi (CN); Xiaotao Xu, Shaanxi (CN); Xiaogang Yang, Shaanxi (CN); Lei Shi, Shaanxi (CN)

(21) Appl. No.: 18/619,404

(22) Filed: Mar. 28, 2024

(30) Foreign Application Priority Data
Jul. 11, 2023 (CN) 202310847460.7

(51) Int. Cl. B01D 53/90; B01D 53/86

(52) U.S. Cl. CPC B01D 53/90; B01D 53/8696; B01D 2251/2062; B01D 2258/0283

(57) ABSTRACT

Provided is a device for spraying an ammoniacal gas in an automatically-adjustable manner based on a flow rate

### CROSS-REFERENCE TO RELATED APPLICATIONS

This application is based on and claims priority to the Chinese Patent Application No. 202310847460.7, filed on Jul. 11, 2023, the entire content of which is incorporated herein by reference.

### FIELD

The present application relates to the field of flue gas purification in a thermal power plant, particularly to a device for spraying an ammoniacal gas in an automatically-adjustable manner based on a flow rate of a flue gas.

### BACKGROUND

At present, for most thermal power plants, nitrogen oxide is removed from the flue gas by a Selective Catalytic Reduction (SCR) denitrification device, where a reduction reaction occurs at a catalyst surface, between the nitrogen oxide and an ammonia-containing gas flow spraying into a gas funnel as a reducing agent. In the SCR denitrification device, the ammonia-containing gas flow is sprayed into the flue gas under pressure through an ammonia spray grille and a nozzle in turn, both of which are in a fixed steel-made form and thus being incapable of adjusting a spray amount of the internal ammonia-containing gas flow along with a changing flow rate of the external flue gas. In practice however, it is impossible to maintain a combustion condition of a boiler absolutely stable due to factors such as a fuel and a combustion mode, thus resulting in fluctuated flow rates of the flue gas as a combustion product over time.

In this circumstance, the practical SCR operation normally involves homogeneous concentrations of the nitrogen oxide and heterogeneous flow rates in a cross-section of the flue channel, where the fluctuated flow rates directly lead to an unmatched ammonia spray amount relative to an actually-demanded ammonia amount, either excessive or insufficient. On one hand, an excessive ammonia spray amount will cause severe deposition of ammonium bisulfate in an air preheater downstream, thus blocking a flow path of a heat exchange element in the air preheater, generating greatly-increased resistance for operation of the air preheater, and severely and adversely affecting safety and stability for operation of the boiler; on the other hand, insufficient ammonia spray amount will lead to insufficient reduction in nitrogen oxide emission, resulting in excessive nitrogen oxide emission.

Currently, to address the excessive or insufficient ammoniacal spray, the ammonia spray amount is subjected to an accurate control strategy in the related art, that is, the ammonia spray amount at an inlet of the SCR denitrification device is controlled in accordance with feedback on a concentration of the nitrogen oxide at an outlet of the SCR denitrification device that is monitored by instrument. Such a control strategy is useful to a certain extent to improve the unmatched ammonia spray amount over a long time period, however with an obvious drawback of a considerable time delay from measuring to adjusting. It will take a long time period from start of measuring to data output (normally tens of seconds to several minutes depending on a measurement principle and a sampling system) plus to make adjustment, during which the operation condition has been fluctuated several times repeatedly, resulting in a different operation condition when actually making adjustment as compared to that when originally measured. Accordingly, it is usually impossible to accurately spray ammonia timely by means of measuring-first and later adjusting.

Therefore, it is still an urgent requirement to provide a device for spraying an ammoniacal gas in an automatically-adjustable manner based on a flow rate of a flue gas.

### SUMMARY

The present disclosure aims to solve at least one of the technical problems in the related art to a certain extent.

For this, an object of the present disclosure is to provide a device for spraying an ammoniacal gas in an automatically-adjustable manner based on a flow rate of a flue gas, thus allowing the ammonia spray amount to match with the flow rate of the flue gas timely and automatically.

In order to achieve the above object, the present disclosure provides in embodiments a device for spraying an ammoniacal gas in an automatically-adjustable manner based on a flow rate of a flue gas, wherein the device is placed in a gas funnel full of the flue gas flowing along a first direction, wherein the device includes:
a housing, along the first direction provided with an inlet receiving the ammoniacal gas and an opposite outlet spraying the ammoniacal gas;
a force suffering plate, arranged outside the housing and opposite to the outlet, and configured to suffer impact from the flue gas and the ammoniacal gas;
a baffle, arranged at an inner wall of the housing and forming an aperture that allows the ammoniacal gas to pass through;
a base, arranged at the inner wall of the housing and away from the outlet relative to the baffle; and
an adjustable assembly, including a pull shaft, a sliding block, and an elastic element,
wherein
the sliding block is arranged inside the housing and movably inserted into the aperture,
the sliding block is of an increasing cross-section along the first direction,
the sliding block is connected to a first end of the pull shaft and a first end of the elastic element at its two opposite ends, respectively,
a second end of the pull shaft is connected to the force suffering plate,
a second end of the elastic element is connected to the base,
the sliding block is configured to be moved along with the force suffering plate through the pull shaft under the impact onto the force suffering plate by the flue gas,
in response to an increasing flow rate of the flue gas that results in a first force onto the force suffering plate being greater than a second force generated by the elastic element, the sliding block is pulled towards the outlet, enabling an increasing volume of the ammoniacal gas to flow through the aperture,
in response to a decreasing flow rate of the flue gas that results in the first force onto the force suffering plate being lower than the second force generated by the elastic element, the sliding block is pulled towards the inlet, enabling a decreasing volume of the ammoniacal gas to flow through the aperture, and
in response to a balancing flow rate of the flue gas that results in the first force onto the force suffering plate being equal to the second force generated by the elastic element, the sliding block stands still, enabling a constant volume of the ammoniacal gas to flow through the aperture.

In an embodiment, the sliding block is in a wedge shape having
two opposite triangle side surfaces that are abutted against the baffle;
a first rectangle side surface that is abutted against the baffle;
a second rectangle side surface to which the pull shaft is connected; and
a slope side surface, forming an acute angle with the first rectangle side surface and allowing a changeable residual aperture as the sliding block moves.

In an embodiment, the second rectangle side surface is of an area larger than that of the aperture.

In an embodiment, the sliding block is provided with a movable limit element, wherein the movable limit element is arranged at the first rectangle side surface of the sliding block, and arranged to be close to the outlet relative to the baffle.

In an embodiment, the movable limit element is arranged within a range for a displacement of the sliding block towards the outlet caused by ¼ to ⅓ maximal flow rate of the flue gas.

In an embodiment, the base is of a height aligning to the first rectangle side surface of the sliding block.

In an embodiment, the device further includes a supporter,
wherein the supporter is arranged to be abutted against the inner wall of the housing at its periphery and to be vertical to the pull shaft,
wherein the supporter is arranged to be close to the outlet relative to the baffle,
wherein the supporter is provided with a linear bearing accommodating the pull shaft,
wherein the linear bearing is configured to limit the pull shaft to move along the first direction or an opposite second direction.

In an embodiment, the pull shaft extends in an axial direction of the housing.

In an embodiment, the outlet is in a gradually converging trumpet shape.

In an embodiment, the outlet is of an outermost diameter less than that of the force suffering plate.

In an embodiment, the elastic element includes a spring.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a schematic diagram showing a device for spraying an ammoniacal gas in an automatically-adjustable manner based on a flow rate of a flue gas in an embodiment of the present disclosure;

FIG. 2 is a schematic diagram showing a sliding block in an embodiment of the present disclosure;

FIG. 3 is a schematic diagram showing a cross-section along the A-A direction in FIG. 1 in an embodiment of the present disclosure.

FIG. 4 is a schematic diagram showing a device for spraying an ammoniacal gas in an automatically-adjustable manner based on a flow rate of a flue gas in an embodiment of the present disclosure.

### REFERENCE SIGNS

1. housing; 2. outlet; 3. base; 4. elastic element; 5. baffle; 6. sliding block; 7. pull shaft; 8. supporter; 9. linear bearing; 10. force suffering plate; 11. limit element

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure. Instead, the embodiments of the present disclosure comprise all the variants, modifications and their equivalents within the spirit and scope of the present disclosure as defined by the claims.

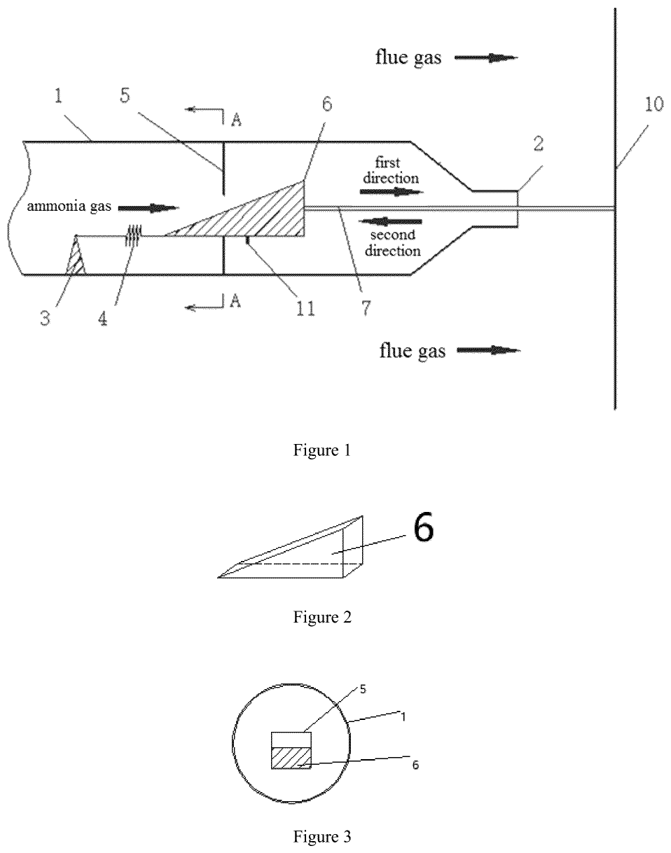

With reference to FIGS. 1 to 4, the present disclosure provides in embodiments a device for spraying an ammoniacal gas in an automatically-adjustable manner based on a flow rate of a flue gas, where the device is placed in a gas funnel full of the flue gas flowing along a first direction. In embodiments, the device includes: a housing 1, a force suffering plate 10, a baffle 5, a base 3, and an adjustable assembly. The housing 1, along the first direction, is provided with an inlet receiving the ammoniacal gas and an opposite outlet 2 spraying the ammoniacal gas. The force suffering plate 10 is arranged outside the housing 1 and opposite to the outlet 2 at a certain distance, and the force suffering plate 10 is configured to suffer impact from the flue gas and the ammoniacal gas. The baffle 5 is arranged at an inner wall of the housing 1 and forms an aperture that allows the ammoniacal gas to pass through. The base 3 is arranged at the inner wall of the housing 1 and away from the outlet 2 relative to the baffle 5. The adjustable assembly includes a pull shaft 7, a sliding block 6, and an elastic element 4. The sliding block 6 is arranged inside the housing and movably inserted into the aperture, thereby allowing the flow-through volume of the ammoniacal gas to be adjustable with the changed residual aperture. The sliding block 6 is of an increasing cross-section along the first direction. The sliding block 6 is connected to a first end of the pull shaft 7 and a first end of the elastic element 4 at its two opposite ends, respectively. A second end of the pull shaft 7 is connected to the force suffering plate 10. A second end of the elastic element 4 is connected to the base 3. The sliding block 6 is configured to be moved along with the force suffering plate 10 through the pull shaft 7 under the impact onto the force suffering plate 10 by the flue gas. The force suffering plate 10 and the elastic element 4 exert opposite forces on the sliding block 6 along the first and second directions respectively. In response to an increasing flow rate of the flue gas that results in a first force onto the force suffering plate 10 being greater than a second force generated by the elastic element 4, the sliding block 6 is pulled towards the outlet 2, enabling an increasing volume of the ammoniacal gas to flow through the aperture. In response to a decreasing flow rate of the flue gas that results in the first force onto the force suffering plate 10 being lower than the second force generated by the elastic element 4, the sliding block 6 is pulled towards the inlet, enabling a decreasing volume of the ammoniacal gas to flow through the aperture. In response to a balancing flow rate of the flue gas that results in the first force onto the force suffering plate 10 being equal to the second force generated by the elastic element 4, the sliding block 6 stands still, enabling a constant volume of the ammoniacal gas to flow through the aperture.

In an embodiment, as shown in FIGS. 1 to 4, the sliding block 6 is in a wedge shape having two opposite triangle side surfaces that are abutted against the baffle 5; a first rectangle side surface that is abutted against the baffle 5; a second rectangle side surface to which the pull shaft 7 is connected; and a slope side surface, forming an acute angle θ with the first rectangle side surface and allowing a changeable residual aperture as the sliding block 6 moves. In an embodiment, the second rectangle side surface is of an area (i.e., the maximal cross-section of the sliding block 6) larger than that of the aperture. In an embodiment, the sliding block 6 is movably inserted into the aperture with the changeable residual aperture for the variable volume of the ammoniacal gas flowing through. In a specific example, the sliding block 6 is capable of blocking the aperture completely.

Accordingly, a displacement of the wedge-shaped sliding block 6 towards the outlet 2 is directly proportional to an area of the residual aperture, such that the area of the residual aperture can be proportionally adjusted in accordance with the displacement of the sliding block 6. In an embodiment, the volume of the ammoniacal gas passing through the aperture increases as the sliding block 6 moves in a same direction as the ammoniacal gas; while the volume of the ammoniacal gas passing through the aperture decreases as the sliding block 6 moves in an opposite direction as the ammoniacal gas. Therefore, in embodiments, the flow rate of the ammoniacal gas passing through the aperture may be maintained stably by controlling a static pressure of the ammoniacal gas upstream of the baffle 5. In other words, the ammonia spray amount is only directly proportional to the displacement of the sliding block 6 towards the outlet 2.

Based on that the sliding block 6 fits to the aperture in terms of their shape and size, it is possible to movably insert the sliding block 6 into the aperture under the changed first and second forces respectively by the force suffering plate 10 and the elastic element 4, thus adjusting the displacement of the sliding block 6 to control the volume of the ammoniacal gas passing through the aperture.

In an embodiment, the ammonia spraying device is placed in a gas funnel full of the flue gas flowing along a first direction for a cold text, when the flue gas is of a flow rate v in a range from 0 to 25 m/s, the wedge-shaped sliding block 6 is of a displacement towards the outlet 2 in a range from 0 to L_{sliding} block (L is shorter than a length of the housing 1), the elastic element 4 is of a stretched length ΔL_{elastic element} which is directly proportional to a pull force F_{elastic element} according to the Hooke's Law (i.e., ΔL_{elastic element}=F_{elastic element}×k, where k is an elastic coefficient). In response to the force suffering plate 10 being of a displacement along the first direction of ΔLₚₗₐₜₑ and the wedge-shaped sliding block 6 being of an acute angle θ between the first rectangle side surface and the slope side surface, and the residual aperture being of a width Wₐₚₑᵣₜᵤᵣₑ, the changed area of the residual aperture would be ΔSₐₚₑᵣₜᵤᵣₑ=ΔLₚₗₐₜₑ×tanθWₐₚₑᵣₜᵤᵣₑ (Formula 1). In other words, when the ammonia spraying device is placed in a gas funnel full of the flue gas flowing along a first direction at the flow rate v, the flue gas impacts onto the force suffering plate 10 with a push force Fₚₗₐₜₑ generated, which drives the wedge-shaped sliding block 6 to move along the first direction, and causes the elastic element 4 to stretch to a certain stretched length, till achieving a balance between the pull force F_{elastic element} and the push force Fₚₗₐₜₑ, where the wedge-shaped sliding block 6 stops moving. As the area of the residual aperture is directly proportional to the push force Fₚₗₐₜₑ against the force suffering plate 10, the area of the residual aperture can be calculated by the Formula 1.

Therefore, by means of configuration of the ammonia spraying device where the displacement of the sliding block 6 towards the outlet 2 is directly proportional to the flow-through volume of the flue gas, the residual aperture of the sliding block 6 is changeable with the flow rate of the flue gas in the gas funnel, i.e., the higher the flow rate of the flue gas is, the larger the push force Fₚₗₐₜₑ against the force suffering plate 10 is, the greater the displacement of the sliding block 6 towards the outlet 2 is, and the larger the residual aperture is, allowing more ammoniacal gas to be sprayed from the outlet 2, such that the ammoniacal gas is sprayed in the automatically-adjustable manner based on the flow rate of the flue gas, thus allowing the ammonia spray amount to match with the flow rate of the flue gas timely.

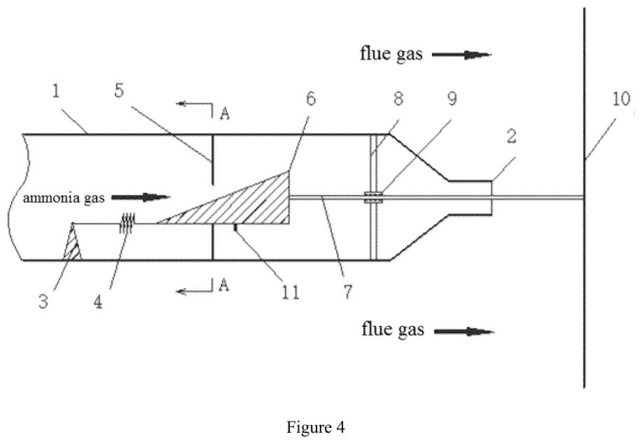

In a further embodiment, as shown in FIGS. 1 and 4, the sliding block 6 is provided with a limit element 11, the limit element 11 is arranged at the first rectangle side surface of the sliding block 6, and the limit element 11 is arranged to be close to the outlet 2 relative to the baffle 5, thereby preventing the aperture from being fully blocked, e.g., avoiding the residual aperture from zero at the very beginning of the system operation when no flue gas is present, thus facilitating pipeline and nozzle purging during maintenance of the ammonia spraying system. In some embodiments, the limit element 11 is movable to be adjusted after debugging of the ammonia spraying device. In some embodiments, the limit element 11 is arranged within a range for the displacement of the sliding block 6 towards the outlet 2 caused by ¼ to ⅓ maximal flow rate of the flue gas.

In an embodiment, as shown in FIGS. 1 and 4, the base 3 is of a height aligning to the first rectangle side surface of the sliding block 6, such that the elastic element 4 connecting both the base 3 and the sliding block 6 extends in the first direction, exerting the pull force F_{elastic element} on the sliding block 6, for resisting the push force Fₚₗₐₜₑ against the force suffering plate 10. Therefore, the configuration of the base 3 ensures the pull force F_{elastic element} in the first direct which is exactly opposite to the push force Fₚₗₐₜₑ.

In an embodiment, as shown in FIG. 4, the device further includes a supporter 8, the supporter 8 is arranged to be abutted against the inner wall of the housing 1 at its periphery and to be vertical to the pull shaft 7, the supporter 8 is arranged to be close to the outlet 2 relative to the baffle 5, the supporter 8 is provided with a linear bearing 9 accommodating the pull shaft 7, and the linear bearing 9 is configured to limit the pull shaft 7 to move along the first direction or an opposite second direction.

In an embodiment, as shown in FIGS. 1 and 4, the pull shaft 7 extends in an axial direction of the housing 1, and the pull shaft 7 is supported by the supporter 8 through the linear bearing 9, thus maintaining the pull shaft 7 to move along the first direction or the opposite second direction. The first end of the pull shaft 7 stretches into the housing 1 through the outlet 2, and connects to the sliding block 6. The opposite second end of the pull shaft 7 stretches out of the housing 1 through the outlet 2, and connects to the force suffering plate 10. In specific, the second end of the pull shaft 7 is fixedly connected to the center of the force suffering plate 10. Upon the impact of the flue gas flowing along the first direction around the housing 1, the force suffering plate 10 moves along the first direction for a certain distance, driving the sliding block 6 to move towards the outlet 2 through the pull shaft, thus adjusting the area of the residual aperture.

In an embodiment, the outlet 2 is in a gradually converging trumpet shape, such that the ammoniacal gas is gradually gathered. In an embodiment, the outlet 2 is of an outermost diameter less than that of the force suffering plate 10. In an embodiment, the center of the outlet 2 coincides with the center of the force suffering plate 10.

In an embodiment, the elastic element 4 includes a spring.

In another aspect, the present disclosure provides in embodiments a method for spraying an ammoniacal gas in an automatically-adjustable manner timely based on a flow rate of a flue gas, using the ammonia spraying device described above. In embodiments, the method includes: under a stable operation condition, the force suffering plate 10 moving along the first direction under the impact of the flue gas onto the force suffering plate 10, driving the sliding block 6 to move synchronously along the first direction through the pull shaft 7 towards the outlet 2 at a certain displacement, resulting in an enlarged residual aperture for an increasing volume of the ammoniacal gas flowing through the aperture, until achieving the balance between the first force (i.e., the push force Fₚₗₐₜₑ) and the second force (i.e., the pull force F_{elastic element}); and under a fluctuated operation condition, in response to a changed flow rate of the flue gas that changes the first force (i.e., the push force Fₚₗₐₜₑ), driving the sliding block 6 to move along the first direction towards the outlet 2, resulting in a changed residual aperture to change the volume of the ammoniacal gas flowing through the aperture, until achieving the balance between the first force and the second force again.

In specific, the flue gas flows along the first direction outside the housing 1, and the ammoniacal gas flows along the first direction inside the housing 1. Under the stable operation condition, upon the impact of the flue gas onto the force suffering plate 10, the sliding block 6 is driven by the push force Fₚₗₐₜₑ to move towards the outlet 2 through the pull shaft 7 fixedly connected to the force suffering plate 10 and constrained by the linear bearing 9; at the same time, the sliding block 6 is also subjected to the pull force F_{elastic element}; and the sliding block 6 stops moving when the balance between the push force Fₚₗₐₜₑ and the pull force F_{elastic element} is achieved, with a particularly proper residual aperture formed, through which the ammoniacal gas flows inside the housing 1 towards the outlet 2 and gathers at the gradually converging trumpet shaped outlet 2 before being sprayed. When the operation condition fluctuates, for example when the flow rate of the flue gas increases suddenly, the push force Fₚₗₐₜₑ of the glue gas onto the force suffering plate 10 also increases suddenly, driving the sliding block 6 to move towards the outlet 2 rapidly through the pull shaft 7; the sliding block 6 stops moving until achieving the balance between the push force Fₚₗₐₜₑ and the pull force F_{elastic element} is achieved again. The volume of the ammoniacal gas spraying from the outlet 2 increases as the residual aperture enlarges; while the volume of the ammoniacal gas spraying from the outlet 2 decreases as the residual aperture enlarges reduces.

Therefore, the entire system with the ammonia spraying device is maintained at the balance between the push force Fₚₗₐₜₑ and the pull force F_{elastic element} all the time, regardless the stable or fluctuated operation condition.

In the specification, it should be understood that, the terms indicating orientation or position relationship such as “central”, “longitudinal”, “lateral”, “width”, “thickness”, “above”, “below”, “front”, “rear”, “right”, “left”, “vertical”, “horizontal”, “top”, “bottom”, “inner”, “outer”, “clockwise”, “counter-clockwise”, “axial”, “radial”, “circumferential” should be construed to refer to the orientation or position relationship as then described or as shown in the drawings. These terms are merely for convenience and concision of description and do not alone indicate or imply that the device or element referred to must have a particular orientation or must be configured or operated in a particular orientation. Thus, it cannot be understood to limit the present disclosure.

It should be noted that terms such as “first” and “second” are used herein for purposes of description and are not intended to indicate or imply relative importance or significance or impliedly indicate quantity of the technical feature referred to. In the description of the present disclosure, “a plurality of” means two or more than two this features, unless specified otherwise.

In the present disclosure, unless specified or limited otherwise, the terms “mounted”, “connected”, “coupled”, “fixed” and the like are used broadly, and may be, for example, fixed connections, detachable connections, or integrated connections; may also be mechanical or electrical connections; may also be direct connections or indirect connections via intervening structures; may also be inner communications of two elements or mutual interaction between two elements, which can be understood by those skilled in the art according to specific situations.

Any procedure or method described in the flow charts or described in any other way herein may be understood to comprise one or more modules, portions or parts for storing executable codes that realize particular logic functions or procedures. Moreover, advantageous embodiments of the present disclosure comprise other implementations in which the order of execution is different from that which is depicted or discussed, including executing functions in a substantially simultaneous manner or in an opposite order according to the related functions. This should be understood by those skilled in the art to which embodiments of the present disclosure belong.

In the description of this specification, the reference terms “an embodiment,” “some embodiments,” “example,” “specific example,” or “some examples” are meant to include specific features, structures, materials, or characteristics described in conjunction with this embodiment or example in at least one embodiment or example of this application. In this specification, the indicative expressions of the above terms do not necessarily refer to the same embodiment or example. Moreover, the specific features, structures, materials, or characteristics described can be appropriately combined in any at least one embodiment or example.

Although explanatory embodiments have been shown and described, it would be appreciated by those skilled in the art that the above embodiments cannot be construed to limit the present disclosure, and changes, alternatives, and modifications can be made in the embodiments in the scope of the present disclosure.

What is claimed is:

1. A device for spraying an ammoniacal gas in an automatically-adjustable manner based on a flow rate of a flue gas, wherein the device is placed in a gas funnel full of the flue gas flowing along a first direction, wherein the device comprises:
a housing, along the first direction provided with an inlet receiving the ammoniacal gas and an opposite outlet spraying the ammoniacal gas;
a force suffering plate, arranged outside the housing and opposite to the outlet, and configured to suffer impact from the flue gas and the ammoniacal gas;
a baffle, arranged at an inner wall of the housing and forming an aperture that allows the ammoniacal gas to pass through;
a base, arranged at the inner wall of the housing and away from the outlet relative to the baffle; and
an adjustable assembly, comprising a pull shaft, a sliding block, and an elastic element,
wherein
the sliding block is arranged inside the housing and movably inserted into the aperture,
the sliding block is of an increasing cross-section along the first direction,
the sliding block is connected to a first end of the pull shaft and a first end of the elastic element at its two opposite ends, respectively,
a second end of the pull shaft is connected to the force suffering plate,
a second end of the elastic element is connected to the base,
the sliding block is configured to be moved along with the force suffering plate through the pull shaft under the impact onto the force suffering plate by the flue gas,
in response to an increasing flow rate of the flue gas that results in a first force onto the force suffering plate being greater than a second force generated by the elastic element, the sliding block is pulled towards the outlet, enabling an increasing volume of the ammoniacal gas to flow through the aperture,
in response to a decreasing flow rate of the flue gas that results in the first force onto the force suffering plate being lower than the second force generated by the elastic element, the sliding block is pulled towards the inlet, enabling a decreasing volume of the ammoniacal gas to flow through the aperture, and
in response to a balancing flow rate of the flue gas that results in the first force onto the force suffering plate being equal to the second force generated by the elastic element, the sliding block stands still, enabling a constant volume of the ammoniacal gas to flow through the aperture.

2. The device according to claim 1, wherein the sliding block is in a wedge shape having
two opposite triangle side surfaces that are abutted against the baffle;
a first rectangle side surface that is abutted against the baffle;
a second rectangle side surface to which the pull shaft is connected; and
a slope side surface, forming an acute angle with the first rectangle side surface and allowing a changeable residual aperture as the sliding block moves.

3. The device according to claim 2, wherein the second rectangle side surface is of an area larger than that of the aperture.

4. The device according to claim 2, wherein the sliding block is provided with a movable limit element, wherein the movable limit element is arranged at the first rectangle side surface of the sliding block, and arranged to be close to the outlet relative to the baffle.

5. The device according to claim 4, wherein the movable limit element is arranged within a range for a displacement of the sliding block towards the outlet caused by ¼ to ⅓ maximal flow rate of the flue gas.

6. The device according to claim 2, wherein the base is of a height aligning to the first rectangle side surface of the sliding block.

7. The device according to claim 1, further comprising a supporter,
wherein the supporter is arranged to be abutted against the inner wall of the housing at its periphery and to be vertical to the pull shaft,
wherein the supporter is arranged to be close to the outlet relative to the baffle,
wherein the supporter is provided with a linear bearing accommodating the pull shaft,
wherein the linear bearing is configured to limit the pull shaft to move along the first direction or an opposite second direction.

8. The device according to claim 7, wherein the pull shaft extends in an axial direction of the housing.

9. The device according to claim 1, wherein the outlet is in a gradually converging trumpet shape.

10. The device according to claim 9, wherein the outlet is of an outermost diameter less than that of the force suffering plate.

11. The device according to claim 1, wherein the elastic element comprises a spring.
